(19) United States
(12) Patent Application Publication
(10) Pub. No.: US 2008/0292834 A1
(43) Pub. Date: Nov. 27, 2008

(54) MULTIPLE LAYER GLAZING BILAYER HAVING A MASKING LAYER

(76) Inventor: Steven Vincent Haldeman, Hampden, MA (US)

Correspondence Address: BRENC LAW;ANDREW BRENC, P.O. BOX 155, ALBION, PA, 16401-0155, US

(21) Appl. No.: 11/752,293

(22) Filed: May 22, 2007

(51) Int. Cl. B32B 17/10

(52) U.S. Cl. 428/98; 156/106

(57) ABSTRACT

The present invention provides multiple layer glazing bilayers that utilize a masking layer over the polymer film component. The masking layer is specifically formulated to have a melting point that is less than the temperature employed in the autoclave process that is used to laminate the bilayer. The surprising result of the use of the specified masking layer of the present invention is a bilayer that can be processed according to conventional lamination methods but with a reduction in the damage and optical defects that normally occur during processing and installation of the bilayer product. After installation, the masking layer can be removed, exposing the previously protected, underlying polymer film.

### FIELD OF THE INVENTION

The present invention is in the field of multiple layer glazing panels, and, specifically, the present invention is in the field of multiple layer glazing panels that have a single rigid substrate, such as glass or rigid plastic.

### BACKGROUND

Safety glass is a multiple layer glazing construct that typically employs a polymeric interlayer disposed between two layers of glass. Conventionally, safety glass of this type has been manufactured by placing a polymer layer between two layers of glass and laminating the three layers by applying heat and pressure to produce a finished, multiple layer glass panel. The resulting glazing panel resists penetration of an object because the polymer layer adheres strongly to the glass but remains flexible and energy absorbent.

Many variations on this theme have been reported. For example, the interlayer can be a single polymer layer, or it can comprise multiple polymer layers. In addition to polymer layers, other functional layers can be included as part of an interlayer, including, for example, a polymer film that improves one or more characteristics of the finished product.

A safety glazing panel that uses only one rigid substrate, for example, a pane of glass or a pane of rigid plastic, is known in the art as a “bilayer.” In order to provide optimal optical clarity, a bilayer typically is formed with an interlayer, as described above, disposed between a rigid substrate and a relatively stiff polymer film. The polymer film provides the necessary stiffness to maintain a relatively smooth surface, which allows for optical clarity that would not be possible with only a polymer layer.

One type of bilayer is formed by laminating a polymer layer between a glass panel and a thin polyester film. Such a construct is suitable for applications, for example, in which a full two pane safety panel is either not desired or not practical. Bilayers can be used, for example, in the side windows of vehicles, where the full thickness of a two pane glass safety panel is generally undesirable.

Despite their desirability for various applications, however, conventional bilayers can present various problems that are inherent in the single rigid substrate design. For example, the polymer film can sustain damage during processing and prior to final installation, which can lead to an unacceptable level of optical defects in the final product.

Accordingly, further improved bilayer multiple layer glazing panels and methods for making those panels are needed in the art.

### SUMMARY OF THE INVENTION

The present invention provides multiple layer glazing bilayers that utilize a masking layer over the polymer film component. The masking layer is specifically formulated to have a melting point that is less than the temperature employed in the autoclave process that is used to laminate the bilayer. The surprising result of the use of the specified masking layer of the present invention is a bilayer that can be processed according to conventional lamination methods but with a reduction in the damage and optical defects that normally occur during processing and installation of the bilayer product. After installation, the masking layer can be removed, exposing the previously protected, underlying polymer film.

### BRIEF DESCRIPTION OF THE DRAWINGS

FIG. 1 represents a schematic cross sectional view of a bilayer of the present invention incorporating a masking layer.

FIG. 2 represents a schematic cross sectional view of a bilayer of the present invention incorporating a masking layer and prior to lamination.

FIG. 3 represents a schematic cross sectional view of various bilayer embodiments of the present invention.

FIG. 4 represents a schematic cross sectional view of various bilayer embodiments of the present invention.

### DETAILED DESCRIPTION

The present invention relates to an improved glazing bilayer. As used herein, a “bilayer” is a multiple layer glazing construct having a rigid substrate and a polymer film between which is disposed a polymer stack, wherein the polymer stack can comprise a single polymer layer or multiple polymeric layers. The polymer stack in bilayers of the present invention provides a similar function to interlayers used in standard two glass pane safety glass. Interlayers used in standard safety glass, like the polymer stack of the present invention, can comprise a single polymer layer or multiple polymer layers that have been coextruded or laminated together to form the interlayer.

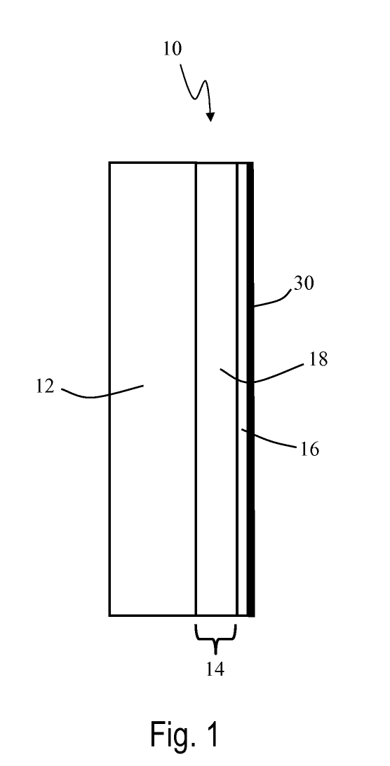

As shown in FIG. 1 generally at 10, in various embodiments a bilayer comprises a rigid substrate 12 and a polymer film 16 between which is disposed a polymer stack 14. For the embodiments shown in FIG. 1, the polymer stack consists of a single polymer layer 18, but, as mentioned above, multiple layer polymer stacks are within the scope of a bilayer of the present invention. A masking layer 30 is shown in position covering the polymer film 16.

As will be described in greater detail below, a polymer layer 18 can comprise any suitable polymer, and, in preferred embodiments, the polymer layer 18 comprises poly(vinyl butyral). As will also be described in detail below, the polymer film 16 can be any suitable polymer film, and, in preferred embodiments, the polymer film comprises poly(ethylene terephthalate). The rigid substrate 12 can be glass, rigid plastic, or any other rigid substrate conventionally used in glazing panels.

The masking layer 30 can be any suitable polymer material that is has a melting temperature that is less than the autoclave temperature used during the lamination process. Melting temperature is the critical parameter for the masking layer, it has been surprisingly discovered, because lamination at less than the melting temperature results in any surface distortion in the masking layer pushing through into the polymer film, which results in visible distortion in the finished product. Such distortion is lessened or eliminated by employing masking layers of the present invention.

Suitable polymeric materials for the masking layer include those that can be applied to the polymer film of the bilayer, that remain adhered to the polymer film through processing, that can be readily removed after completion or installation of the glazing panel, and that have a melting point in the specified range.

In various embodiments, the melting temperature of the masking layer is less than 150° C., less than 140° C., or less than 130° C. Examples of useful polymeric materials that can be used as the masking layer include pressure sensitive polymers, such as acrylics, and heat activated adhesive materials, such as ethylene vinyl acetates (EVA), having the desired melting points. In preferred embodiments, materials that can be formed into masking layers that have a peel adhesion of 0.1 Newtons/centimeter (N/cm) to 0.5 N/cm, or 0.1 N/cm to 0.3 N/cm are used.

In a preferred embodiment, low density polyethylene is used (available in one form as “Novacel 9390” from Novacel Inc., Newton, Mass.).

In various embodiments, the masking layer has a thickness of 0.025 to 0.25 millimeters (1 to 10 mils), 0.025 to 0.13 millimeters (1 to 5 mils), or 0.025 to 0.051 millimeters (1 to 2 mils).

Masking layers of the present invention can be applied to the polymer film surface in any suitable manner, including, for example and without limitation, by using an adhesive to bond the masking layer or by forming the masking layer directly on the polymer film. The masking layer can be applied to the polymer film at any point in processing. For example, the masking layer can be applied to the polymer film before the polymer film is disposed in contact with the polymer layer, after the polymer film has been “prelaminated” with the polymer layer, or after the polymer layer and polymer film have been placed in contact with a rigid glazing substrate but prior to lamination.

Masking layers of the present invention can be readily removed from the polymer film at some point after lamination. Removal can be, for example, as simple as peeling the masking layer off of the bilayer panel by hand or by tool, or through the application of a solvent or chemical that allows the masking layer to be removed.

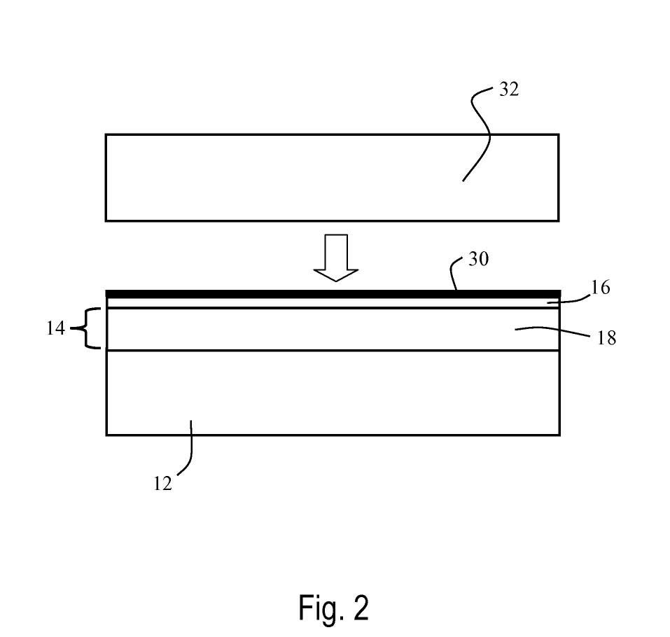

FIG. 2 shows a bilayer of the present invention that is ready for lamination. As shown, the masking layer 30 is disposed in contact with a polymer film 16, which is disposed in contact with a polymer layer 18, which is disposed in contact with a rigid glazing substrate 12. A second rigid substrate 32, which can be a pane of glass, is temporarily placed in contact with the masking layer 30 prior to lamination. After lamination by any suitable, conventional technique, for example by a nip roll autoclave process, the second rigid substrate 32 can be removed, leaving the masking layer adhered to the polymer film. The second rigid substrate 32 can be treated with release agents prior to being put in contact with the masking layer 30 to facilitate separation after lamination, as desired.

An alterative method for laminating bilayer panels is provided in U.S. Patent Publication 20060157186.

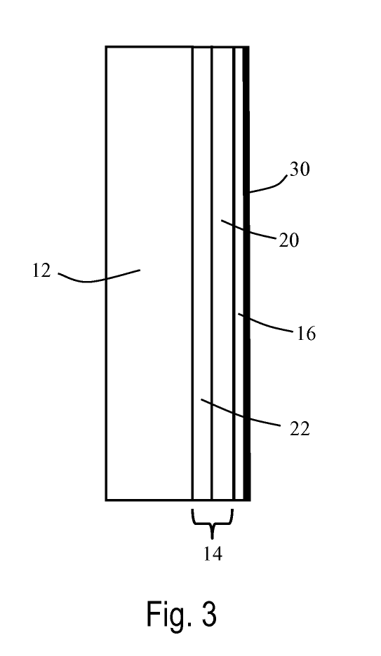

FIG. 3 shows other embodiments of the present invention, in which the polymer stack 14 comprises more than a single polymer layer. As shown, a first polymer layer 20 and a second polymer layer 22 have been combined to form the polymer stack 14, which is disposed between a rigid substrate 12 and the polymer film 16. The masking layer 30 is disposed in contact with the polymer film 16.

Of course, embodiments in which three or more polymer layers are combined to form the polymer stack are within the scope of the present invention. Individual polymer layers in a polymer stack can be the same or different. For example, in some embodiments two different types of polymer layers are used, and in others, two polymer layers having the same polymeric content are used, but each polymer layer differs in the type and amount of additional agents that are included.

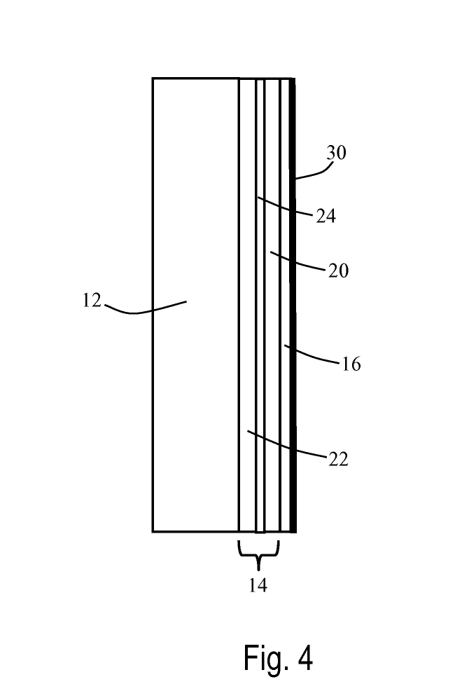

FIG. 4 shows yet further embodiments in which the polymer stack, in additional to two polymer layers, also includes a functional performance polymer film 24. As shown, the polymer stack 14 comprises a first polymer layer 20 and a second polymer layer 22 with a second polymer film 24 disposed therebetween. In these embodiments, the second polymer film 24 can be the same or different from the polymer film 16, and, as above for the embodiments shown in FIG. 3, the two polymer layers can be the same or different.

Embodiments such as those shown in FIGS. 3 and 4 provide a means through which various agents and performance enhancing layers can be included within a polymer stack to achieve results that would be difficult or impossible with a single polymer layer polymer stack.

Further included in the scope of the present invention are variations on the polymer stacks that are explicitly shown and described herein. For example, further polymer film layers and polymer layers can be added to the polymer stack in many arrangements to produce a bilayer within the scope of the present invention.

Further included within the scope of the present invention are polymer stacks produced through extrusion coating or coextrusion processes. For example, the polymer stack shown in FIG. 3 can be formed by coextruding two polymers to form the two layers shown, in addition to a conventional lamination procedure.

### Polymer Film

As used herein, a “polymer film” means a relatively thin and rigid polymer layer that functions as a performance enhancing layer within a polymer stack or as the outside layer in a bilayer, as shown as element 16 in the Figures. Polymer films differ from polymer layers, as used herein, in that polymer films do not themselves provide the necessary impact resistance and glass retention properties to a multiple layer glazing structure, but rather provide performance improvements, such as infrared absorption character, or in the case of the outer layer, as a rigid surface. Poly(ethylene terephthalate) is most commonly used as a polymer film.

Polymer films used in the present invention can be any suitable film that is sufficiently rigid to provide a relatively flat, stable surface, for example those polymer films conventionally used as a performance enhancing layer in multiple layer glass panels. The polymer film is preferably optically transparent (i.e. objects adjacent one side of the layer can be comfortably seen by the eye of a particular observer looking through the layer from the other side), and usually has a greater, in some embodiments significantly greater, tensile modulus regardless of composition than that of the adjacent polymer layer. In various embodiments, the polymer film comprises a thermoplastic material. Among thermoplastic materials having suitable properties are nylons, polyurethanes, acrylics, polycarbonates, polyolefins such as polypropylene, cellulose acetates and triacetates, vinyl chloride polymers and copolymers, and the like. In various embodiments, the polymer film comprises materials such as re-stretched thermoplastic films having the noted properties, for example, polyesters. In various embodiments, the polymer film comprises or consists of poly(ethylene terephthalate), and, in various embodiments, the poly(ethylene terephthalate) has been biaxially stretched to improve strength and/or has been heat stabilized to provide low shrinkage characteristics when subjected to elevated temperatures (e.g. less than 2% shrinkage in both directions after 30 minutes at 150° C.).

In various embodiments, a polymer film within a polymer stack can have a thickness of 0.013 millimeters to 0.25 millimeters, 0.025 millimeters to 0.1 millimeters, or 0.04 millimeters to 0.06 millimeters. In various embodiments, a polymer film that is used as the outside polymer film (element 16 in the Figures) can have a thickness of 0.1 millimeters to 0.25 millimeters, 0.13 millimeters to 0.22 millimeters, or 0.16 millimeters to 0.20 millimeters.

The polymer film can optionally be surface treated or coated with a functional performance layer to improve one or more properties, such as adhesion or infrared radiation reflection. These functional performance layers include, for example, a multi-layer stack for reflecting infra-red solar radiation and transmitting visible light when exposed to sunlight. This multi-layer stack is known in the art (see, for example, WO 88/01230 and U.S. Pat. No. 4,799,745) and can comprise, for example, one or more Angstroms-thick metal layers and one or more (for example, two) sequentially deposited, optically cooperating dielectric layers. As is also known (see, for example, U.S. Pat. Nos. 4,017,661 and 4,786,783), the metal layer(s) may optionally be electrically resistance heated for defrosting or defogging of any associated glass layers.

Various coating and surface treatment techniques for poly(ethylene terephthalate) films and other polymer films that can be used with the present invention are disclosed in published European Application No. 0157030. Polymer films of the present invention can also include a hardcoat and/or an antifog layer, as are known in the art.

### Hardcoats

In various embodiments, polymer films of the present invention comprise a hardcoat. A hardcoat can function to protect the underlying layer from mechanical damage or deterioration caused by exposure to the environment.

Any suitable, conventional hardcoat can be used on a polymer film of the present invention. In particular, the hardcoats may be a combination of poly(silicic acid) and copolymers of fluorinated monomers, with compounds containing primary alcohols (as described in U.S. Pat. No. 3,429,845), or with compounds containing primary or secondary alcohols (as described in U.S. Pat. No. 3,429,846). Other abrasion resistant coating materials suitable for the purpose are described in U.S. Pat. Nos. 3,390,203; 3,514,425; and, 3,546,318.

Further examples of useful hardcoats include cured products resulting from heat or plasma treatment of a hydrolysis and condensation product of methyltriethoxysilane.

Hardcoats that are useful also include acrylate functional groups, such as a polyester, polyether, acrylic, epoxy, urethane, alkyd, spiroacetal, polybutadiene or polythiol polyene resin having a relatively low molecular weight; a (meth)acrylate oligomer or prepolymer of a polyfunctional compound such as a polyhydric alcohol; or a resin containing, as a reactive diluent, a relatively large amount of a monofunctional monomer such as ethyl(meth)acrylate, ethylhexyl(meth)acrylate, styrene, methylstyrene or N-vinylpyrrolidone, or a polyfunctional monomer such as trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate or neopentyl glycol di(meth)acrylate.

In various embodiments, acrylate hard coats are preferred, and particularly urethane acrylates.

### Polymer Layer

As used herein, a “polymer layer” means any polymer composition formed by any suitable method into a thin layer that is suitable alone, or in stacks of more than one layer, for use as a polymer stack (interlayer) that provides adequate penetration resistance and glass retention properties to laminated glazing panels such as bilayer panels. Plasticized poly(vinyl butyral) is most commonly used to form polymer layers.

The polymer layer can comprise any suitable polymer, and, in a preferred embodiment, the polymer layer comprises poly(vinyl butyral). In any of the embodiments of the present invention given herein that comprise poly(vinyl butyral) as the polymeric component of the polymer layer, another embodiment is included in which the polymer component consists of or consists essentially of poly(vinyl butyral). In these embodiments, any of the variations in additives disclosed herein can be used with the polymer layer having a polymer consisting of or consisting essentially of poly(vinyl butyral).

In one embodiment, the polymer layer comprises a polymer based on partially acetalized poly(vinyl alcohol)s. In another embodiment, the polymer layer comprises a polymer selected from the group consisting of poly(vinyl butyral), polyurethane, poly(vinyl chloride), poly(ethylene-co-vinyl acetate), partially neutralized ethylene/(meth)acrylic copolymers, ionomers, combinations thereof, and the like. In further embodiments the polymer layer comprises poly(vinyl butyral) and one or more other polymers.

Other polymers having a suitable glass transition temperature can also be used. In any of the sections herein in which preferred ranges, values, and/or methods are given specifically for poly(vinyl butyral) (for example, and without limitation, for plasticizers, component percentages, thicknesses, and characteristic-enhancing additives), those ranges also apply, where applicable, to the other polymers and polymer blends disclosed herein as useful as components in polymer layers.

For embodiments comprising poly(vinyl butyral), the poly(vinyl butyral) can be produced by known acetalization processes that involve reacting poly(vinyl alcohol) with butyraldehyde in the presence of an acid catalyst, followed by neutralization of the catalyst, separation, stabilization, and drying of the resin.

As used herein, “resin” refers to the polymeric (for example poly(vinyl butyral)) component that is removed from the mixture that results from the acid catalysis and subsequent neutralization of the polymeric precursors. Resin will generally have other components in addition to the polymer, for example poly(vinyl butyral), such as acetates, salts, and alcohols.

Details of suitable processes for making poly(vinyl butyral) resin are known to those skilled in the art (see, for example, U.S. Pat. Nos. 2,282,057 and 2,282,026). In one embodiment, the solvent method described in Vinyl Acetal Polymers, in Encyclopedia of Polymer Science & Technology, 3^{rd} edition, Volume 8, pages 381-399, by B. E. Wade (2003) can be used. In another embodiment, the aqueous method described therein can be used. Poly(vinyl butyral) is commercially available in various forms from, for example, Solutia Inc., St. Louis, Mo. as Butvar™ resin.

In various embodiments, the polymer layer comprises poly(vinyl butyral) having a molecular weight greater than 30,000, 40,000, 50,000, 55,000, 60,000, 65,000, 70,000, 120,000, 250,000, or 350,000 grams per mole (g/mole or Daltons). Small quantities of a dialdehyde or trialdehyde can also be added during the acetalization step to increase molecular weight to greater than 350,000 Daltons (see, for example, U.S. Pat. Nos. 4,874,814; 4,814,529; and 4,654,179). As used herein, the term “molecular weight” means the weight average molecular weight.

Any suitable plasticizers can be added to the polymer resins of the present invention in order to form the polymer layers. Plasticizers used in the polymer layers of the present invention can include esters of a polybasic acid or a polyhydric alcohol, among others. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, mixtures of phosphates and adipates such as those disclosed in U.S. Pat. No. 3,841,890 and adipates such as those disclosed in U.S. Pat. No. 4,144,217, and mixtures and combinations of the foregoing. Other plasticizers that can be used are mixed adipates made from C₄ to C₉ alkyl alcohols and cyclo C₄ to C₁₀ alcohols, as disclosed in U.S. Pat. No. 5,013,779, and C₆ to C₈ adipate esters, such as hexyl adipate. In preferred embodiments, the plasticizer is triethylene glycol di-(2-ethylhexanoate).

Polymer layers can comprise 20 to 60, 25 to 60, 20 to 80, 10 to 70, or 5 to 100 parts plasticizer phr. Of course other quantities can be used as is appropriate for the particular application. In some embodiments, the plasticizer has a hydrocarbon segment of fewer than 20, fewer than 15, fewer than 12, or fewer than 10 carbon atoms.

Adhesion control agents (ACAs) can also be included in the polymer layers of the present invention to impart the desired adhesiveness. Any of the ACAs disclosed in U.S. Pat. No. 5,728,472 can be used. Additionally, residual sodium acetate and/or potassium acetate can be adjusted by varying the amount of the associated hydroxide used in acid neutralization. In various embodiments, polymer layers of the present invention comprise, in addition to sodium acetate and/or potassium acetate, magnesium bis(2-ethyl butyrate)(chemical abstracts number 79992-76-0). The magnesium salt can be included in an amount effective to control adhesion of the polymer layer to glass.

Additives may be incorporated into the polymer layer to enhance its performance in a final product. Such additives include, but are not limited to, plasticizers, dyes, pigments, stabilizers (e.g., ultraviolet stabilizers), antioxidants, flame retardants, other IR absorbers, UV absorbers, anti-block agents, combinations of the foregoing additives, and the like, as are known in the art.

Agents that selectively absorb light in the visible or near infrared spectrum can be added to any of the appropriate polymer layers. Agents that can be used include dyes and pigments such as indium tin oxide, antimony tin oxide, or lanthanum hexaboride (LaB₆).

One exemplary method of forming a poly(vinyl butyral) layer comprises extruding molten poly(vinyl butyral) comprising resin, plasticizer, and additives, and then forcing the melt through a sheet die (for example, a die having an opening that is substantially greater in one dimension than in a perpendicular dimension). Another exemplary method of forming a poly(vinyl butyral) layer comprises casting a melt from a die onto a roller, solidifying the melt, and subsequently removing the solidified melt as a sheet. As used herein, “melt” refers to a mixture of resin with a plasticizer and, optionally, other additives. In either embodiment, the surface texture at either or both sides of the layer may be controlled by adjusting the surfaces of the die opening or by providing texture at the roller surface. Other techniques for controlling the layer texture include varying parameters of the materials (for example, the water content of the resin and/or the plasticizer, the melt temperature, molecular weight distribution of the poly(vinyl butyral), or combinations of the foregoing parameters). Furthermore, the layer can be configured to include spaced projections that define a temporary surface irregularity to facilitate the de-airing of the layer during lamination processes after which the elevated temperatures and pressures of the laminating process cause the projections to melt into the layer, thereby resulting in a smooth finish.

In various embodiments, the polymer stacks of the present invention can have total thicknesses of 0.1 to 3.0 millimeters, 0.2 to 2.0 millimeters, 0.25 to 1.75 millimeters, and 0.3 to 1.5 millimeters, although other thicknesses, including greater thicknesses, are within the scope of the present invention. The individual polymer layers of a multiple layer polymer stack can have, for example, approximately equal thicknesses that, when added together, result in the total thickness ranges given above. Of course, in other embodiments, the thicknesses of the layers can be different, and can still add to the total thicknesses given above.

Bilayers of the present invention can be formed through any suitable process. In various embodiments, a bilayer is formed by stacking and then laminating the following layers: glass//polymer layer//polymer film//masking layer//glass. Lamination of this stack can be performed by any appropriate laminating process in the art, including known autoclave procedures. After lamination, the pane of glass that is in contact with the masking layer can be peeled off of the polymer film, leaving a single pane of glass having a polymer layer disposed thereon with a polymer film disposed on the polymer layer and the masking layer disposed on the polymer film. Any multiple layer polymer stack of the present invention can be substituted for the polymer layer in these methods (i.e. glass//polymer stack//polymer film//masking layer//glass).

The present invention also includes methods of manufacturing any of the bilayers of the present invention comprising using a vacuum non-autoclave process. In various embodiments of the present invention, a bilayer of the present invention is manufactured using a vacuum deairing non-autoclave process embodiment as described in U.S. Pat. No. 5,536,347. In various other embodiments, a nip roll non-autoclave process embodiment described in published U.S. application US 2003/0148114 A1 is used.

The present invention also includes methods of making a bilayer, comprising disposing a polymer stack of the present invention between a rigid substrate and a polymer film, with a masking layer, and laminating the construct to form a bilayer.

The present invention also includes methods of making a bilayer, comprising forming a masking layer on a polymer film, at any suitable point, as detailed above, assembling the polymer film/masking layer with a polymer stack and a rigid substrate, and laminating the entire assembly to form a multiple layer bilayer panel.

The present invention also includes a composite polymeric construct for use with a rigid glazing substrate, wherein the “composite polymeric construct” is any of the polymer stack/polymer film/masking layer constructs of the present invention disclosed herein.

The following paragraphs describe various techniques that can be used to measure the characteristics of the polymer layer.

The clarity of a polymer layer can be determined by measuring the haze value, which is a quantification of the light scattered by a sample in contrast to the incident light. The percent haze can be measured according to the following technique. An apparatus for measuring the amount of haze, a Hazemeter, Model D25, which is available from Hunter Associates (Reston, Va.), can be used in accordance with ASTM D11003-61 (Re-approved 1977)-Procedure A, using Illuminant C, at an observer angle of 2 degrees. In various embodiments of the present invention, percent haze is less than 5%, less than 3%, or less than 1%.

The visible transmittance can be quantified using a UV-Vis-NIR spectrophotometer such as the Lambda 900 made by Perkin Elmer Corp. by methods described in international standard ISO 9050:1990. In various embodiments, the transmittance through a polymer layer of the present invention is at least 60%, at least 70%, or at least 80%.

Pummel adhesion can be measured according to the following technique, and where “pummel” is referred to herein to quantify adhesion of a polymer layer to glass, the following technique is used to determine pummel. Two-ply glass laminate samples are prepared with standard autoclave lamination conditions. The laminates are cooled to about −17.8° C. (0° F.) and manually pummeled with a hammer to break the glass. All broken glass that is not adhered to the poly(vinyl butyral) layer is then removed, and the amount of glass left adhered to the poly(vinyl butyral) layer is visually compared with a set of standards. The standards correspond to a scale in which varying degrees of glass remain adhered to the poly(vinyl butyral) layer. In particular, at a pummel standard of zero, no glass is left adhered to the poly(vinyl butyral) layer. At a pummel standard of 10, 100% of the glass remains adhered to the poly(vinyl butyral) layer. Poly(vinyl butyral) layers of the present invention can have, for example, a pummel value of between 3 and 10.

Peel adhesion is a measure of the adhesion between a polymer sheet and a polymer film (or a polymer sheet and glass), and can be determined according to the following procedure: a laminate having a polymer film in contact with a polymer sheet is cut to allow a 4 cm wide strip of polymer film to be peeled off of the polymer sheet at an angle of 90° and a speed of 127 mm/minute. The peel force is measured by an Instron load cell model A2-38 which is calibrated at 0.0 and 5.0 kg prior to testing.

### EXAMPLE 1

Two bilayer laminates are prepared in an identical manner.

A glass pane, a poly(vinyl butyral) layer with a thickness of 0.76 millimeters (0.030 inches)(Saflex HMG2, available from Solutia, Inc., St. Louis, Mo.), a standard poly(ethylene terephthalate) film with a thickness of 193 micrometers and a hardcoat, and a low density polyethylene film (Novacel 9390) as a masking layer are placed in a stack. The melting temperature of the masking film is 115° C. Lamination is performed using a nip roll and using a standard autoclave pressure of 1.275×10⁶ Pascals (185 pounds per square inch) and either a temperature of 100° C. or a temperature of 143° C. After autoclaving, some optical distortions are observable by eye in the laminate that is autoclaved at 100° C., while no distortion is visible in the laminate that is autoclaved at 143° C.

By virtue of the present invention, it is now possible to provide bilayers having a protective masking film that can be laminated in standard conditions and that is capable of preventing optical distortion. Such bilayers can be used in, for example, glazing panels, such as laminated glass panels for windshields and architectural windows.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, a bilayer can be formed comprising a masking layer having any of the given thicknesses and having any of the given materials to form many permutations that are within the scope of the present invention, but that would be exceedingly cumbersome to list.

Any Figure reference numbers given within the abstract or any claims are for illustrative purposes only and should not be construed to limit the claimed invention to any one particular embodiment shown in any figure.

Figures are not drawn to scale unless otherwise indicated.

Each reference, including journal articles, patents, applications, and books, referred to herein is hereby incorporated by reference in its entirety.

1. A laminated bilayer glazing panel, comprising:
a rigid substrate;
a polymer film;
a polymer stack disposed between and in contact with said rigid substrate and said polymer film, wherein said polymer stack comprises a polymer layer; and,
a masking layer comprising low density polyethylene disposed in contact with said polymer film, opposite said polymer stack, wherein said masking layer has a melting point of less than the temperature employed to laminate said bilayer glazing panel.

2. The bilayer of claim 1, wherein said masking layer has a melting point of less than 150° C.

3. The bilayer of claim 1, wherein said masking layer has melting point of less than 140° C.

4. The bilayer of claim 1, wherein said masking layer has melting point of less than 130° C.

5. The bilayer of claim 1, wherein said polymer stack consists essentially of said polymer layer.

6. The bilayer of claim 1, wherein said polymer stack comprises an additional polymer layer.

7. The bilayer of claim 1, wherein said polymer layer comprises poly(vinyl butyral).

8. The bilayer of claim 1, wherein said rigid substrate is glass.

9. The bilayer of claim 1, wherein said masking layer has a thickness of 0.025 to 0.13 millimeters.

10. The bilayer of claim 1, wherein said masking layer is adhered to said polymer film with a peel adhesion strength of 0.1 N/cm to 0.3 N/cm.

11.-19. (canceled)

20. A method of making a bilayer glazing panel, comprising:
providing a rigid substrate;
providing a polymer film;
providing a polymer stack disposed between and in contact with said rigid substrate and said polymer film, wherein said polymer stack comprises a polymer layer;
providing a masking layer comprising low density polyethylene disposed in contact with said polymer film, opposite said polymer stack; and,
laminating said rigid substrate, said polymer film, said polymer stack, and said masking layer in an autoclave to form said bilayer, wherein said masking layer has a melting point that is less than the temperature of the autoclave.

21. The method of claim 20, wherein said masking layer has a melting point of less than 150° C.

22. The method of claim 20, wherein said masking layer has melting point of less than 140° C.

23. The method of claim 20, wherein said masking layer has melting point of less than 130° C.

24. The method of claim 20, wherein said polymer stack consists essentially of said polymer layer.

25. The method of claim 20, wherein said polymer stack comprises an additional polymer layer.

26. The method of claim 20, wherein said polymer layer comprises poly(vinyl butyral).

27. The method of claim 20, wherein said rigid substrate is glass.

28. The method of claim 20, wherein said masking layer has a thickness of 0.025 to 0.13 millimeters.

29. The method of claim 20, wherein said masking layer is adhered to said polymer film with a peel adhesion strength of 0.1 N/cm to 0.3 N/cm.
